(19) United States
(12) Patent Application Publication
(10) Pub. No.: US 2013/0235108 A1
(43) Pub. Date: Sep. 12, 2013

(54) INKJET RECORDING APPARATUS, IMAGE PROCESSING APPARATUS, AND IMAGE PROCESSING METHOD

(71) Applicant: FUJIFILM CORPORATION, Tokyo (JP)

(72) Inventors: Tomohiro MIZUNO, Ashigarakami-gun (JP); Osamu SHIMAZAKI, Ashigarakami-gun (JP)

(73) Assignee: FUJIFILM CORPORATION, Tokyo (JP)

(21) Appl. No.: 13/789,098

(22) Filed: Mar. 7, 2013

(30) Foreign Application Priority Data
Mar. 8, 2012 (JP) 2012-051641

(51) Int. Cl. B41J 2/045

(52) U.S. Cl. CPC B41J 2/04558
USPC 347/15

(57) ABSTRACT

An inkjet recording apparatus includes: a registration shift amount setting device configured to relatively set, between inkjet heads corresponding to colors different to each other, a registration shift amount of recording positions in a nozzle row direction of the inkjet heads; an interpolated image generating device configured to generate, in accordance with the registration shift amount, image data of an interpolated image from, among original image data representing tone values of the respective colors, the original image data of one of the colors corresponding to the inkjet head for which the registration shift amount has been set; a halftone processing device configured to generate color-specific halftone images by performing halftone processing on the image data of the interpolated image and the original image data of the other colors; and an ejection control device configured to control ejection operations of the inkjet heads in accordance with the color-specific halftone images.

### BACKGROUND OF THE INVENTION

1. Field of the Invention

The present invention relates to an inkjet recording apparatus, an image processing apparatus, and an image processing method, and more particularly to an inkjet recording apparatus which forms a color image by using color-specific recording heads corresponding to inks of a plurality of colors, and to image processing technology used in the inkjet recording apparatus.

2. Description of the Related Art

A normal inkjet system which prints color images on recording media using inks of a plurality of colors is provided with color-specific recording heads (inkjet heads) corresponding to a plurality of ink colors, such as cyan (C), magenta (M), yellow (Y) and black (K or Bk), for example. The inkjet heads each have nozzle rows in which a plurality of nozzles configured to eject ink droplets are arranged, and ejection operations from the nozzles are controlled so as to eject and deposit ink droplets onto a recording medium on the basis of the image data, while moving the recording medium relatively with respect to the nozzle rows, whereby an image is formed on the recording medium.

With respect to the inkjet heads arranged for the respective types of ink used, the nozzle positions and the droplet ejection timings are adjusted between the respective inkjet heads in such a manner that the ejected ink droplets are deposited onto the same positions on the recording medium to form dots of the colors on the recording medium. Under the presumption that the adjustment of the nozzle positions and the adjustment of the droplet ejection timings have been carried out accurately, halftone processing of the image data to be printed is carried out to generate dot data, and the ink ejection operations from the respective inkjet heads are controlled on the basis of the generated dot data.

However, in an actual apparatus, deviations in the ejection directions occurs for various reasons in the nozzles of the inkjet heads, and the deposition positions of the ink droplets may deviate from ideal design positions, or the envisaged positions upon the adjustment. As a result of such deviations in the deposition positions of the ink droplets, an unintentional light/dark shading distribution of the ink occurs on the recording medium, and this is ultimately perceived as stripe non-uniformities.

In particular, at a location where no ink droplet is present at a position where an ink droplet ought to be present, or a location where a deposition position deviation has occurred to such an extent that the surface of the recording medium (for example, a white color if using white paper) is visible, a stripe non-uniformity is especially notable and produces an image defect.

Moreover, even in cases where the positions of the inkjet heads are adjusted so as to be able to eject droplets to form dots of the colors at the same positions on the recording medium, an unexpected deviation or shift in the registration (hereinafter referred to as the “registration shift”) may occur between the inkjet heads during continuous use of the inkjet heads. For example, in order to maintain ejection properties, the inkjet heads are subjected to a maintenance processing (head cleaning) such as cleaning of the nozzle surfaces, pressurized purging (preliminary ejection), nozzle suctioning, and the like, at a suitable timing. During the maintenance processing, the inkjet heads are moved (withdrawn) from an image formation position where the inkjet heads face to the recording medium, to a head maintenance position outside the image formation region, and after the maintenance processing, the inkjet heads are returned again to the image formation position. When such the head movement is repeated, the registration shift can occur between the inkjet heads.

As stated previously, in the inkjet printing system, normally, the positions of the inkjet heads are adjusted so that there is no registration shift, and image processing and printing are carried out on this basis. Therefore, if the registration is unexpectedly shifted between the inkjet heads, a color non-uniformity becomes visible on the printed recording medium.

### SUMMARY OF THE INVENTION

The present invention has been contrived in view of these circumstances, an object thereof being to provide an inkjet recording apparatus, an image processing apparatus and an image processing method, to reduce stripe non-uniformities produced by ejection direction errors (deposition position deviations) of the nozzles of the inkjet heads, and/or to reduce color non-uniformities caused by registration shift in the inkjet heads.

In order to attain the aforementioned object, the present invention is directed to an inkjet recording apparatus, comprising: a plurality of inkjet heads which are arranged correspondingly to inks of a plurality of colors, each of the inkjet heads having nozzles configured to eject droplets of the ink of the corresponding color to deposit the ejected droplets of the ink onto a recording medium; a relative movement device which is configured to cause relative movement of the recording medium with respect to the inkjet heads in a first direction; a registration shift amount setting device which is configured to relatively set, between the inkjet heads corresponding to the colors different to each other, a registration shift amount of recording positions in a nozzle row direction of the inkjet heads along a second direction perpendicular to the first direction; an interpolated image generating device which is configured to generate image data of an interpolated image from, among original image data representing tone values of the respective colors, the original image data of one of the colors corresponding to the inkjet head for which the registration shift amount has been set by the registration shift amount setting device, the image data of the interpolated image being generated in accordance with the registration shift amount; a halftone processing device which is configured to generate color-specific halftone images by performing halftone processing on the image data of the interpolated image of the one of the colors and the original image data of the others of the colors; and an ejection control device which is configured to control, in accordance with the color-specific halftone images generated by the halftone processing device, ejection operations of the inkjet heads of the corresponding colors.

According to this aspect of the invention, in the inkjet recording apparatus including the plurality of inkjet heads, which are arranged for the respective types (colors) of inks, the registration shift amount is set in the nozzle row direction between the inkjet heads of the different colors, and the positions of droplet deposition points created by the respective inkjet heads are varied between the different colors. According this composition, even if ink droplets cannot be deposited at the originally intended positions due to the occurrence of deviations in the ejection directions of the nozzles (deposition position deviations), because the dot arrangement is adopted in which the ink droplets ejected from the nozzles of other colors are situated in a close vicinity, then stripe non-uniformities are not conspicuous.

Furthermore, according to this aspect of the invention, before halftone processing which is carried out on the image data that represents tone values of the respective colors, the interpolated image which takes account of the previously ascertained registration shift amount between the inkjet heads is generated, and therefore it is possible to suppress the occurrence of color non-uniformities caused by the registration shift.

Preferably, the plurality of colors include four colors of cyan, magenta, yellow and black.

By setting the registration shift in respect of the colors having relatively high visibility, of the plurality of colors, it is possible to increase the effect of reducing stripe non-uniformities.

Preferably, the registration shift amount set by the registration shift amount setting device is smaller than a pixel pitch in the second direction which is specified by a recording resolution in the second direction of the inkjet heads.

Preferably, the registration shift amount set by the registration shift amount setting device is obtained by dividing the pixel pitch in the second direction into n equal parts, where n is an integer larger than one.

Preferably, the inkjet heads include a black head configured to eject black ink, and a magenta head configured to eject magenta ink; and the registration shift amount setting device sets the registration shift amount such that the black head and the magenta head are staggered relatively to each other by ½ of the pixel pitch in the second direction.

It is also preferable that the inkjet heads include a black head configured to eject black ink, and a cyan head configured to eject cyan ink; and the registration shift amount setting device sets the registration shift amount such that the black head and the cyan head are staggered relatively to each other by ½ of the pixel pitch in the second direction.

It is also preferable that the inkjet heads include a magenta head configured to eject magenta ink, and a cyan head configured to eject cyan ink; and the registration shift amount setting device sets the registration shift amount such that the magenta head and the cyan head are staggered relatively to each other by ½ of the pixel pitch in the second direction.

The invention is not limited to the mode which sets the registration shift amount between the two inkjet heads, and it is also possible to set a registration shift amount between three or four inkjet heads. If a registration shift amount is applied respectively between n inkjet heads, then it is desirable to employ a composition which respectively sets a registration shift amount of 1/n of pixel pitch, which is obtained by dividing the pixel pitch (nozzle pitch) in the nozzle row direction into n equal parts.

It is also preferable that the inkjet heads include a black head configured to eject black ink, a magenta head configured to eject magenta ink, and a cyan head configured to eject cyan ink; and the registration shift amount setting device sets the registration shift amount such that the black head, the magenta head and the cyan head are staggered relatively to each other by ⅓ of the pixel pitch in the second direction.

It is also preferable that the inkjet heads include a black head configured to eject black ink, a magenta head configured to eject magenta ink, a cyan head configured to eject cyan ink, and a yellow head configured to eject yellow ink; and the registration shift amount setting device sets the registration shift amount such that the black head, the magenta head, the cyan head and the yellow head are staggered relatively to each other by ¼ of the pixel pitch in the second direction.

Preferably, the interpolated image generating device is configured to perform interpolation processing from the original image data in accordance with the registration shift amount and information on a recording resolution in the second direction of the inkjet heads, and is configured to generate the image data of the interpolated image representing tone values which are re-sampled at interpolation positions taking account of the registration shift amount.

In order to attain the aforementioned object, the present invention is also directed to an image processing apparatus for an inkjet recording apparatus which includes: a plurality of inkjet heads which are arranged correspondingly to inks of a plurality of colors, each of the inkjet heads having nozzles configured to eject droplets of the ink of the corresponding color to deposit the ejected droplets of the ink onto a recording medium; and a relative movement device which is configured to cause relative movement of the recording medium with respect to the inkjet heads in a relative movement direction, the image processing apparatus comprising: a registration shift amount storage device which is configured to store a registration shift amount of recording positions in a nozzle row direction of the inkjet heads perpendicular to the relative movement direction, the registration shift amount being relatively set between the inkjet heads corresponding to the colors different to each other; an interpolated image generating device which is configured to generate image data of an interpolated image from, among original image data representing tone values of the respective colors, the original image data of one of the colors corresponding to the inkjet head for which the registration shift amount has been set, the image data of the interpolated image being generated in accordance with the registration shift amount; and a halftone processing device which is configured to generate color-specific halftone images by performing halftone processing on the image data of the interpolated image of the one of the colors and the original image data of the others of the colors.

The information on the registration shift amount which is stored in the registration shift amount storage device can be information on the registration shift amount which is beforehand set between the inkjet heads with the object of reducing the visibility of stripe non-uniformities. Furthermore, instead of or in combination with the mode which stores information on the registration shift amount that can be set as desired in this way, it is also possible to adopt a mode which actually measures or determines the registration shift between the inkjet heads and stores information on the registration shift amount obtained as the measurement result, in the registration shift amount storage device.

In order to attain the aforementioned object, the present invention is also directed to a computer readable non-transitory medium storing instructions causing a computer to function as the above-described image processing apparatus.

In order to attain the aforementioned object, the present invention is also directed to an image processing method for an inkjet recording apparatus which includes: a plurality of inkjet heads which are arranged correspondingly to inks of a plurality of colors, each of the inkjet heads having nozzles configured to eject droplets of the ink of the corresponding color to deposit the ejected droplets of the ink onto a recording medium; and a relative movement device which is configured to cause relative movement of the recording medium with respect to the inkjet heads in a relative movement direction, the method comprising: a registration shift amount storage step of storing a registration shift amount of recording positions in a nozzle row direction of the inkjet heads perpendicular to the relative movement direction, the registration shift amount being relatively set between the inkjet heads corresponding to the colors different to each other; an interpolated image generating step of generating image data of an interpolated image from, among original image data representing tone values of the respective colors, the original image data of one of the colors corresponding to the inkjet head for which the registration shift amount has been set, the image data of the interpolated image being generated in accordance with the registration shift amount; and a halftone processing step of generating color-specific halftone images by performing halftone processing on the image data of the interpolated image of the one of the colors and the original image data of the others of the colors.

The registration shift amount storage step can store information on the registration shift amount which is beforehand set between the inkjet heads with the object of reducing the visibility of stripe non-uniformities. Furthermore, instead of or in combination with the mode which stores information on the registration shift amount that can be set as desired in this way, it is also possible to adopt a mode which implements a step of actually measuring or determining the registration shift between the inkjet heads (a registration shift amount measurement step) and stores information on the registration shift amount obtained as the measurement result, in the registration shift amount storage step.

According to the present invention, it is possible to reduce the visibility of the stripe non-uniformities caused by the deviations of the ejection directions. Furthermore, according to the present invention, it is also possible to suppress the color non-uniformities caused by the registration shift between the inkjet heads.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram of a composition of an inkjet printing system according to an embodiment of the present invention;

FIG. 2 shows, at a portion (a), a schematic view of an example of printing by an inkjet recording apparatus in the related art, and at a portion (b), a schematic view of a problem of a stripe non-uniformity caused by the inkjet recording apparatus in the related art;

FIG. 3 shows, at a portion (a), an illustrative diagram of a means of solution according to the present embodiment, and at a portion (b), an illustrative diagram of an effect of reducing the visibility of stripe non-uniformities according to the present embodiment;

FIGS. 4A to 4C are illustrative diagrams showing registration shift setting examples;

FIGS. 5A and 5B are illustrative diagrams showing further registration shift setting examples;

FIG. 6 is an illustrative diagram of causes of color non-uniformities caused by registration shift in the inkjet printing in the related art;

FIG. 7 is an illustrative diagram of image processing according to the present embodiment;

FIG. 8 is an illustrative diagram showing an example of color separation image data for the respective colors of C, M, Y, K, in a target reproduction image;

FIG. 9 is an illustrative diagram showing image formation results in a case where the M head has a registration shift with respect to the color separation image data in FIG. 8;

FIG. 10 is an illustrative diagram showing an example of color separation image data including an interpolated image for M which takes account of the registration shift amount;

FIG. 11 is an illustrative diagram showing an example of M color separation image;

FIG. 12 is an illustrative diagram of interpolation processing for generating the interpolated image;

FIG. 13 is an illustrative diagram of interpolation processing for generating the interpolated image;

FIG. 14 is a block diagram showing a procedure of image processing in an image processing device; and

FIG. 15 is a flowchart showing a procedure of image processing according the present embodiment.

### DESCRIPTION OF THE PREFERRED EMBODIMENTS

### First Embodiment

### <Composition of Inkjet Printing System>

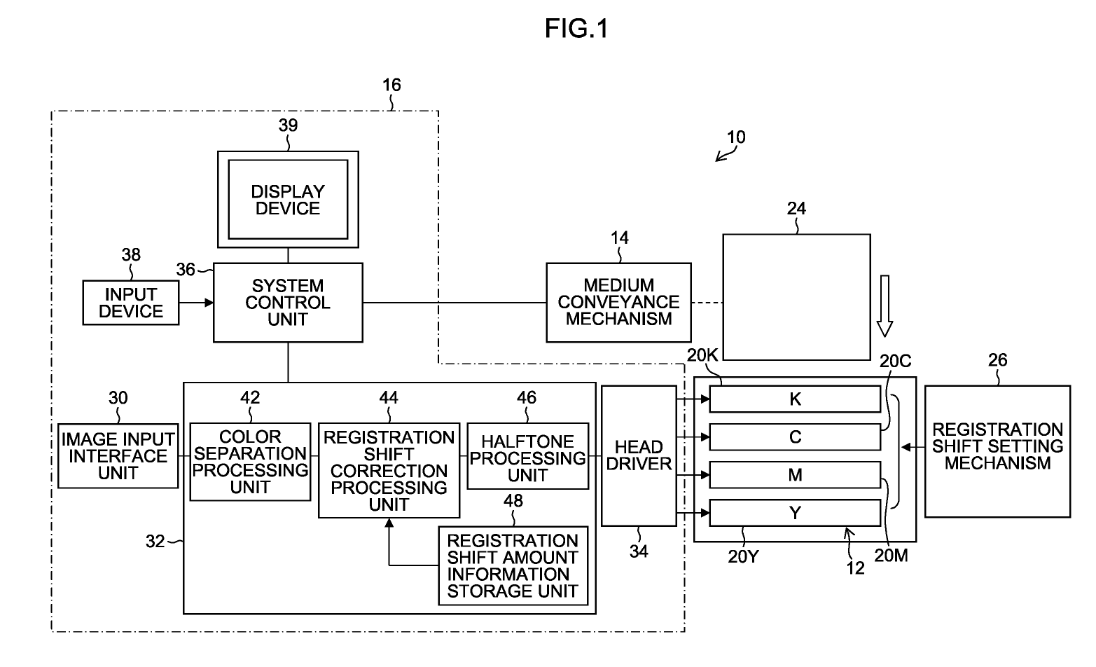

FIG. 1 is a block diagram showing a composition of an inkjet printing system 10 according to an embodiment of the present invention. The inkjet printing system 10 (corresponding to an “inkjet recording apparatus”) includes an ink ejection mechanism 12, a medium conveyance mechanism 14, and a control unit 16. The ink ejection mechanism 12 includes a plurality of inkjet heads (hereinafter referred simply to as “heads”) 20K, 20C, 20M and 20Y, which correspond respectively to a plurality of ink colors. In the present embodiment, an example is described in which inks of four colors, cyan (C), magenta (M), yellow (Y) and black (K) are used, and the ink ejection mechanism 12 is provided with the color-specific heads 20K, 20C, 20M and 20Y for ejecting the inks of the respective colors; however, the number of ink colors and the combination of ink colors are not limited to this example. For example, apart from the four colors of CMYK, it is also possible to adopt a mode which additionally includes light inks, such as light cyan (LC) and light magenta (LM), or the like, or a mode which uses special color inks, such as red or green inks. In the description given below, elements which are common to the respective heads 20K, 20C, 20M and 20Y of the respective colors (elements of which the ink color does not need to be specified in the description), are denoted with the reference numeral 20 and described as the “head(s) 20”.

The inkjet printing system 10 in the present embodiment is a so-called single pass type of printing apparatus, in which a printing medium 24 (corresponding to a “recording medium”, also referred to as “paper”) is conveyed in a medium conveyance direction (corresponding to a “first direction”, also referred to as a “sub-scanning direction” or “y direction”), and each head 20 has a nozzle row in which a plurality of ink ejecting nozzles are arranged through a length corresponding to the full area of an image formation region (the maximum width of the image formation region) in a paper width direction (corresponding to a “second direction”, also referred to as a “main scanning direction” or “x direction”), which is perpendicular to the medium conveyance direction. The scope of application of the present invention is not limited to the single pass method, and the present invention can also be applied to an apparatus based on a multi-pass method.

As the nozzle arrangement mode in each head 20, it is possible to adopt a one-dimensional nozzle configuration, in which the nozzles are arranged on a straight line (in one row) at a uniform spacing apart, or to adopt a so-called staggered matrix configuration, in which two nozzle rows are arranged so as to be mutually staggered in the nozzle row direction by a pitch of ½ of the nozzle interval (nozzle pitch) in each of the nozzle rows. In particular, in order to achieve a high recording resolution, a desirable composition is one in which the nozzles are arranged two-dimensionally on the ink ejection surface, such as a matrix arrangement in which three or more nozzle rows are arranged.

In the case of the inkjet head having the two-dimensional nozzle arrangement, a projected nozzle row in which the nozzles in the two-dimensional nozzle arrangement are projected (by orthogonal projection) to an alignment in a direction (corresponding to the paper width direction or main scanning direction) that is perpendicular to the paper conveyance direction (corresponding to the medium conveyance direction or sub-scanning direction) can be regarded as equivalent to a single nozzle row in which the nozzles are arranged at roughly even spacing at a nozzle density that achieves the recording resolution in the main scanning direction (the medium width direction). Here, “roughly even spacing” means substantially even intervals between the droplet deposition points which can be recorded by the inkjet printing system. For example, the concept of “even spacing” also includes cases where there is slight variation in the intervals, to take account of manufacturing errors or movement of the droplets on the medium due to landing interference. Taking account of the projected nozzle row (also referred to as the “effective nozzle row”), it is possible to associate the nozzle positions (nozzle numbers) in the alignment sequence of the projected nozzles which are aligned following the main scanning direction. In the description given below, reference to “nozzle positions” means the positions of the nozzles in the effective nozzle rows. The nozzle pitch of the effective nozzle row corresponds to the “pixel pitch in the second direction which is specified by the recording resolution in the second direction”.

Although the detailed structure of the head 20 is not illustrated, the head 20 has ejection energy generating elements (for example, piezoelectric elements or heat generating elements), which are arranged correspondingly to the respective nozzles and configured to generate ejection energy required for ink ejection from the corresponding nozzles, and ink droplets are ejected on demand in accordance with input signal values.

The ink ejection mechanism 12 in the present embodiment has a registration shift setting mechanism 26, as a device capable of setting an amount of shift (hereinafter referred to as the “registration shift amount”) of the recording positions in the nozzle row direction (main scanning direction) relatively between the heads of different colors. The registration shift setting mechanism 26 includes a mechanism configured to move at least one of the heads 20 of the ink ejection mechanism 12 in the main scanning direction (paper width direction), whereby the position of the head 20 in the main scanning direction can be adjusted finely.

It is possible that all of the heads 20 of the respective colors are provided with the mechanisms (head position adjustment mechanisms) configured to adjust the head positions (i.e., the recording positions with respect to the medium 24). Alternatively, it is also possible that specific one or more of the heads 20 only are provided with the mechanisms configured to adjust the head positions so that the head positions are adjustable relatively to the positions of the other heads. If all of the heads 20 are provided with the position adjustment mechanisms, then it is possible to suitably set a registration shift amount for any combination of all of the heads 20 of the respective colors. On the other hands, if only a part of the heads 20 is provided with the position adjustment mechanism, then although there are certain limits on the setting of the registration shift amount, it is possible to simplify the composition of the registration shift setting mechanism 26 and to reduce the cost of the apparatus by adopting a mode in which only the head of the ink color that has a high effect in reducing the visibility of color non-uniformities is provided with the position adjustment mechanism, and the like.

The medium conveyance mechanism 14 is configured to convey the medium 24 forming a printing medium, such as a printing paper. Here, the medium conveyance mechanism 14 conveys the medium 24 at a uniform speed in the sub-scanning direction perpendicular to the lengthwise direction of the heads 20 of the ink ejection mechanism 12. The medium conveyance mechanism 14 can employ various types of conveyance method, such as a drum conveyance method, a belt conveyance method, or a nip conveyance method. Although the detailed structure of the medium conveyance mechanism 14 is not illustrated, the medium conveyance mechanism 14 includes a paper supply roller, a conveyance motor, a motor drive circuit, and the like. Since the heads 20 and the medium 24 are moved relatively to each other by conveying the medium 24 in the uniform direction by the medium conveyance mechanism 14, the medium conveyance mechanism 14 corresponds to a “relative movement device” in the inkjet printing system 10 based on the single pass system.

The control unit 16 is configured to function as a device to control the ejection operations of the heads 20 of the ink ejection mechanism 12 and the operation of the medium conveyance mechanism 14, as well as functioning as a device to process the image signal for printing, and a calculating device to carry out various calculations. More specifically, the control unit 16 is configured to control the medium conveyance mechanism 14 and the respective heads 20 on the basis of image data and control signals, and the like, received from a host computer (not shown), or the like, and is configured to implement control for printing an image on a medium 24.

The control unit 16 includes: an image input interface unit 30, which acquires image data; an image processing device 32, which processes the image data that has been acquired; a head driver 34, which generates ejection control signals on the basis of data generated by the image processing device 32; a system control unit 36, which implements overall control of the system; an input device 38; and a display device 39.

The control unit 16 can be achieved, for example, by a hardware composition of a personal computer (PC) and a program (software) which achieves the target functions.

The control unit 16 receives the input image data, such as RGB or CMYK data, generates an interpolated image while taking account of the registration shift amount between the heads, finally generates a so-called halftone (dot) signal for each color of the ink liquid, and outputs signals indicating the ejection timings, colors and droplet sizes (dot sizes) to the ink ejection mechanism 12.

The image input interface unit 30 configured to function as the input section for the image data can employ a wired or wireless communication interface unit, or a media interface section configured to perform reading and writing from and to an external storage medium (e.g., a removable disk) such as a memory card, or a combination of these.

The image processing device 32 includes a color separation processing unit 42, a registration shift correction processing unit 44, and a halftone processing unit 46. The color separation processing unit 42 converts the input image data to generate ink volume data for the respective colors taking account of color matching and the image structure quality. In the present embodiment, the inks of four colors, CMYK, are used and therefore separate image data for each of the four ink colors CMYK is generated. If light cyan (LC) and light magenta (LM) inks are also used in addition to the four colors of CMYK, then ink volume data for each of the six ink colors including LC and LM (i.e., C, M, Y, K, LC and LM) is generated.

In the color separation processing, commonly known color conversion processing and/or resolution conversion processing is carried out in cases where there is a difference between the color space of the input image and the color space reproduced by the ink ejection mechanism 12, or where there is a difference between the resolution of the input image and the output resolution achieved by the present system. For example, if the input original image data is 24-bit RGB full-color image data (8 bits per color), then the color conversion processing from the RGB color space to the CMYK color space is carried out, and separate continuous tone data for the respective colors of CMYK (four-colors data) is generated. If the input original image data is CMY continuous tone data, then the color conversion processing from the CMY color space to the CMYK color space is carried out, and separate continuous tone data for the respective colors of CMYK (four-colors data) is generated. If the input original image data is CMYK continuous tone data, then the color conversion processing is unnecessary, and the data can be separated into separate continuous tone data for the respective colors of CMYK (hereinafter referred to as the “color separation image data”).

Upon the color separation processing, it is also possible to carry out density correction processing according to requirements. It is possible to carry out the density correction processing, before the color conversion processing, or after the color conversion processing, or after the color separation processing.

As described above, the color separation processing unit 42 carries out processing for separating the color image data inputted through the image input interface unit 30 into the image data of the respective ink colors used in the ink ejection mechanism 12.

The registration shift correction processing unit 44 carries out image signal correction processing (to generate an interpolated image) with respect to the color separation image data so as to prevent the occurrence of stripe non-uniformities and color non-uniformities caused by the registration shift between the heads, in accordance with information on the registration shift amount between the heads in the ink ejection mechanism 12 and information on the resolution in the nozzle row direction (main scanning direction) of the ink ejection mechanism 12. More specifically, the registration shift correction processing unit 44 carries out interpolation processing of the color separation image data in accordance with the information on the registration shift amount and the resolution, thereby generating the interpolated image taking account of the registration shift. The details of the processing are described later.

The information on the registration shift amount between the heads is stored beforehand in a registration shift amount information storage unit 48, and the stored information is referenced during the registration shift correction processing. The information on the registration shift amount can be stored when adjustment has been carried out by the registration shift setting mechanism 26 to apply a registration shift amount between the heads, or the registration shift amount can be measured (observed) at a suitable timing and this measurement value can be stored. For example, a composition can be adopted in which the information on the registration shift amount set by the registration shift setting mechanism 26 is stored in automatically in the registration shift amount information storage unit 48. Alternatively, if the registration shift amount is measured by reading in test chart printing results with a scanner, or the like, or if the registration shift amount is measured by using a magnetic sensor or optical sensor, or the like, then it is possible to adopt a composition in which the information on these measurement results is stored in the registration shift amount information storage unit 48. Of course, instead of or in combination with the automatic storage functions of this kind, it is also possible to adopt a composition in which the information on the registration shift amount is input by an operator though the input device 38. In either case, the information on the registration shift amount is stored as existing information in the registration shift amount information storage unit 48, and the registration shift correction processing (interpolated image generation) is carried out on the basis of the stored information.

The information on the resolution in the nozzle row direction can be stored in the registration shift amount information storage unit 48 together with the information on the registration shift amount, or can be stored in a separate storage device. For instance, the information on the resolution can be stored beforehand in a memory, or the like, as system design information.

The halftone processing unit 46 converts the image signal having continuous tones for each color (for example, 256 tones based on 8 bits per color), in pixel units, into a binary signal which indicates ink ejection or no ink ejection, or into a multiple-value signal indicating what type of droplet to eject if a plurality of ink dot diameters (droplet sizes) can be selected. In general, processing is carried out to convert multiple-tone image data having M values (where M is an integer of 3 or more) into data having N values (where N is an integer of 2 or more and less than M). For example, if the ink ejection mechanism 12 can selectively eject droplets of three types of size, namely, a small droplet, a medium droplet and a large droplet, then the halftone processing unit 46 converts the multiple-tone color separation image data for each color (which has 256 tones, for example) into a signal of four values, namely: “to eject a large droplet of the ink”, “to eject a medium droplet of the ink”, “to eject a small droplet of the ink” and “not to eject the ink”. The halftone processing of this kind can employ a dithering method, error diffusion method, density pattern method, or the like.

In the present embodiment, for the ink color that has been subjected to the registration shift correction processing in accordance with the registration shift amount, the halftone processing is carried out on the interpolated image that has been generated by the registration shift correction processing unit 44, and a halftone signal is thereby generated. On the other hand, for the ink color that has not been subjected to the registration shift correction processing, the halftone processing is carried out on the original color separation image data without changing the sampling position.

On the basis of the thus generated halftone image (dot image data representing the arrangement of dots), signals indicating the ejection timings, colors and sizes are output to the heads 20 through the head driver 34. The head driver 34 includes an amplification circuit, and outputs drive signals for driving the ejection energy generating elements corresponding to the respective nozzles of the heads 20, on the basis of the halftone image data (ink ejection data) supplied from the image processing device 32 and the drive waveform signal. The head driver 34 can also incorporate a feedback control system for maintaining uniform drive conditions in the heads 20.

By applying the drive signal output from the head driver 34 to the heads 20 in this way, ink droplets are ejected from the corresponding nozzles. An image is formed on the medium 24 by controlling the ink ejection from the heads 20 in synchronism with the conveyance speed of the medium 24.

As described above, the ejection volumes and the ejection timings of the ink droplets from the respective nozzles are controlled through the head driver 34 on the basis of the ink ejection data generated by prescribed signal processing in the image processing device 32. Thus, the desired sizes and arrangement of the dots are achieved on the medium 24.

As stated previously, the control unit 16 generates the ejection control signal (print data) for controlling driving of the ejection energy generating elements corresponding to the respective nozzles of the heads 20, in accordance with the input image data, and supplies the thus generated ejection control signal to the heads 20, as well as controlling the conveyance of the medium 24. The control unit 16 determines a position of the medium 24 by an encoder, or the like (not shown), while conveying the medium 24 at a uniform speed, and controls the ejection timings of the respective nozzles. Ejection is performed from the nozzles in accordance with the ejection control signals supplied to the heads 20 from the head driver 34 of the control unit 16, thereby forming an image on the medium 24. A combination of the system control unit 36 and the head driver 34 corresponds to an “ejection control device”.

The input device 38 and the display device 39 function as a user interface (UI). The input device 38 can employ a device of various types, such as a keyboard, a mouse, a touch panel, a tracking ball, and the like, or can use a suitable combination of these. An operator can enter various information and commands by using the input device 38, while looking at the contents displayed on the screen of the display device 39. Furthermore, the operator can also ascertain and confirm the state of the system, and the like, through the display device 39.

<Problem with an Inkjet System in the Related Art>

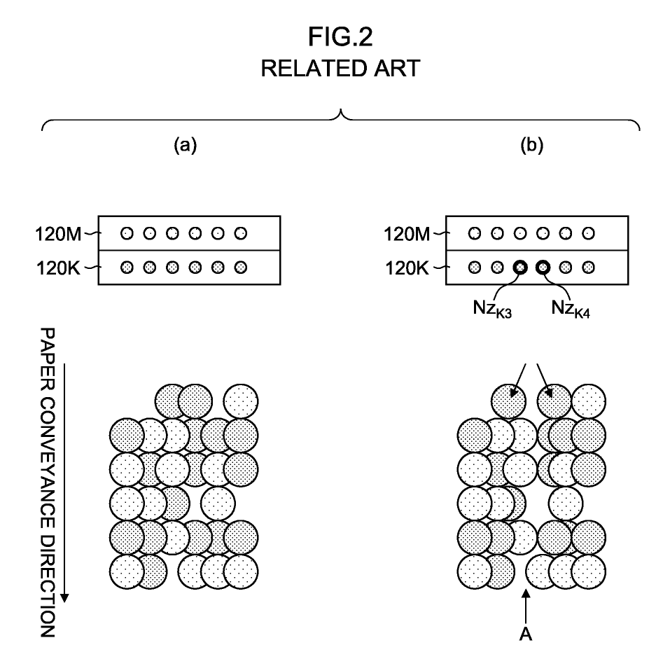

Here, one of problems of an inkjet system in the related art is described. FIG. 2 is a diagram for schematically explaining the problem that occurs in the inkjet printing in the related art. Here, for the purpose of the description, the relationship between two heads, namely, a black head 120K, which ejects black ink, and a magenta head 120M, which ejects magenta ink is explained; and the same applies to other combinations of the colors.

FIG. 2 shows, at a portion (a), an example of ideal droplet deposition in which there is no registration shift between the heads and there is no deviation of the ejection direction (no deposition position deviation) in any nozzle. FIG. 2 further shows, at a portion (b), an example of droplet deposition in a case where ejection direction deviations (deposition position deviations) have occurred in particular nozzles (Nz_{K3} and Nz_{K4}) of the black head 120K, in a state where there is no registration shift between the heads.

As shown in FIG. 2 at the portion (a), in the printing results created by ideal droplet deposition where there is no registration shift between the heads and where no deviation of the ejection direction (no deposition position deviation) occurs in any of the nozzles, the droplets ejected from the nozzles are deposited at correct positions and the target dot arrangement corresponding to the image data is obtained.

However, in actual inkjet printing, deviations in the ejection directions of the nozzles (deposition position deviations) and the like, occur, and the ideal dot arrangement is not obtained. FIG. 2 shows, at the portion (b), a state where the deviations of the ejection directions occur in such a manner that the deposition position of each droplet ejected from the nozzle Nz_{K3} of the black head 120K deviates to the left-hand side, and the deposition position of each droplet ejected from the nozzle Nz_{K4} deviates to the right-hand side, as a result of which a longitudinal stripe (a stripe in the longitudinal direction following the paper feed direction) occurs at the position indicated with an arrow A. As shown in FIG. 2 at the portion (b), in an actual system, stripe non-uniformities occur due to deviations in the ejection directions of the nozzles.

### <First Solution According to the Present Embodiment>

In the present embodiment, the problem illustrated in FIG. 2 at the portion (b) is solved by the following means.

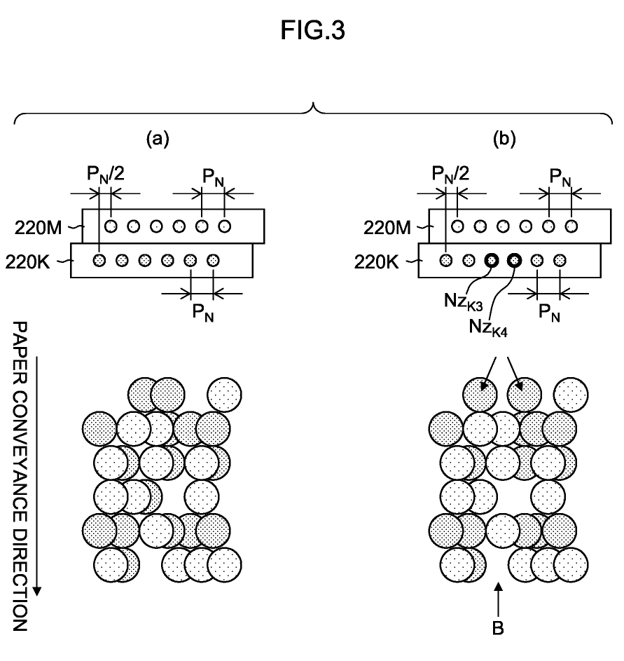

FIG. 3 is an illustrative diagram of means of solution according to the present embodiment. As shown in FIG. 3 at a portion (a), a head arrangement is adopted in which the positional relationship between the nozzle row of the black head 220K and the nozzle row of the magenta head 220M is relatively staggered in the nozzle row direction. Here, the nozzle pitch in the nozzle row (the droplet deposition pitch, in other words, the pixel pitch in the nozzle row direction) is taken to be P_{N} and the amount of stagger between the heads in the nozzle row direction is taken to be half the droplet deposition pitch P_{N} (namely, P_{N}/2).

In this way, the positions of the two heads are adjusted by originally setting a registration shift of P_{N}/2 in the nozzle row direction between the black head 220K and the magenta head 220M. In this head arrangement, the printing results created by ideal droplet ejection when there are no deviations of the ejection directions (no deposition position deviations) in the nozzles shows an ideal dot arrangement corresponding to the image data, in which the droplets ejected from the nozzles are deposited at accurate positions.

FIG. 3 shows, at a portion (b), an example of droplet deposition in a case where ejection direction deviations (deposition position deviations) have occurred in particular nozzles (Nz_{K3} and Nz_{K4}) of the black head 220K, in the head arrangement in which the positions of the black head 220K and the magenta head 220M have been adjusted by originally setting the registration shift of P_{N}/2 in the nozzle row direction between the black head 220K and the magenta head 220M. FIG. 3 shows, at the portion (b), a state where the ejection direction deviations have occurred in such a manner that the deposition position of each droplet ejected from the nozzle Nz_{K3} of the black head 220K deviates to the left-hand side, and the deposition position of each droplet ejected from the nozzle Nz_{K4} deviates to the right-hand side. As shown in in FIG. 3 at the portion (b), since there is a magenta droplet deposition point present (at the position indicated with an arrow B) between the dot formed of the droplet deposited by the nozzle Nz_{K3} and the dot formed of the droplet deposited by the nozzle Nz_{K4} in which the deviations of the ejection directions have occurred, a benefit is obtained in that a longitudinal stripe due to the deviations of the ejection directions is not conspicuous.

In this way, by beforehand applying the registration shift having the amount smaller than the pixel pitch in the nozzle row direction (the droplet deposition pitch in the nozzle row direction) between the heads, it is possible to suppress the visibility of stripe non-uniformities caused by the deviations in the ejection directions (deposition position deviations) of the nozzles.

### <Example of Setting Registration Shift Amount Between Heads>

More specifically, from the viewpoint of obtaining an image in which stripe non-uniformities caused by the deviations in the ejection directions are not conspicuous (an image which is highly robust with respect to the deviations in the ejection directions), it is desirable to use a head arrangement which actively staggers the registration positions of the heads 20. With regard to the amount of stagger (amount of shift) in this case, it is desirable that the registration shift amount is adjusted in such a manner that the original droplet deposition pitch in the nozzle row direction of the system is divided into n equal parts (where n is an integer of 2 or more). Moreover, it is desirable that the registration shift amount is adjusted with reference to the deposition positions of black droplets, which are readily visible as a color, in such a manner that a cyan or magenta droplet is deposited at an exactly halfway position between the deposition positions of the black droplets.

Examples of setting the registration shift amount between the heads so as to achieve a high stripe non-uniformity visibility reducing effect are described below.

### First Example

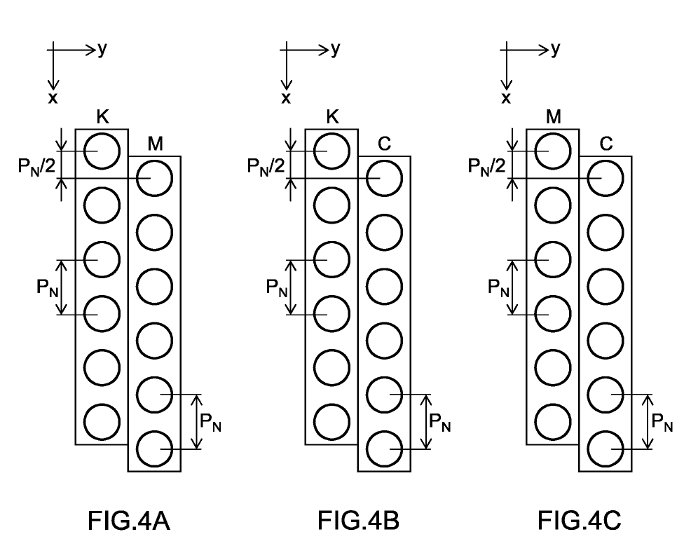

FIG. 4A shows a first example. As shown in FIG. 4A, a registration shift amount is set between the K head for ejecting the black ink and the M head for ejecting the magenta ink in such a manner that the two heads are staggered relatively to each other by exactly half the nozzle pitch P_{N} in the direction (nozzle row direction, x direction) which is perpendicular to the printing direction (the y direction in FIG. 4A). In this case, the C head for ejecting the cyan ink and the Y head for ejecting the yellow ink can be set to the head positions which achieve the same droplet deposition positions as the K head or the staggered M head. In other words, the heads which are not staggered (the C head and the Y head in the first example) can be aligned arbitrarily with either the K head or the M head. However, if the heads are essentially not staggered, for instance, if the C head and the Y head are aligned with the K head, the composition is beneficial in that resampling becomes unnecessary or deviation of a color which is conspicuous such as K can be remedied by other colors.

### Second Example

FIG. 4B shows a second example. As shown in FIG. 4B, a registration shift amount is set between the K head and the C head in such a manner that the two heads are staggered relatively to each other by exactly half the nozzle pitch P_{N} in the direction (nozzle row direction, x direction) which is perpendicular to the printing direction (the medium conveyance direction). In this case, the M head and the Y head can be set to the head positions which achieve the same droplet deposition positions as the K head or the staggered C head.

### Third Example

FIG. 4C shows a third example. As shown in FIG. 4C, a registration shift amount is set between the M head and the C head in such a manner that the two heads are staggered relatively to each other by exactly half the nozzle pitch P_{N} in the direction (nozzle row direction, x direction) which is perpendicular to the printing direction (the medium conveyance direction). In this case, the K head and the Y head can be set to the head positions which achieve the same droplet deposition positions as the M head or the staggered C head.

### Fourth Example

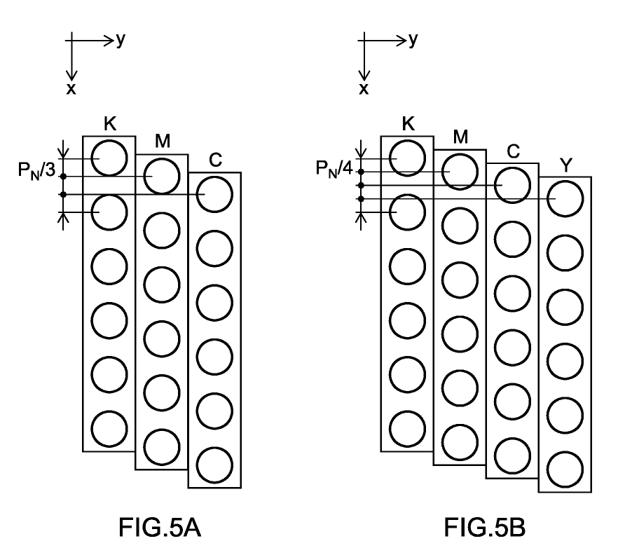

FIG. 5A shows a fourth example. As shown in FIG. 5A, it is possible to adopt an arrangement in which the heads corresponding respectively to the three colors of K, M and C, which have relatively high visibility of the ink colors, are each staggered by one third of the nozzle pitch P_{N} in the nozzle row direction. The head arrangement sequence is not limited to the example shown in FIG. 5A. Furthermore, in this case, the Y head can be set to the head position which achieves the same droplet deposition positions as the K head or the staggered C head or the staggered M head.

### Fifth Example

FIG. 5B shows a fifth example. As shown in FIG. 5B, it is possible to adopt an arrangement in which the heads corresponding respectively to the four colors used are each staggered by one fourth of the nozzle pitch P_{N} in the nozzle row direction. The head arrangement sequence is not limited to the example shown in FIG. 5B.

As described in the first to fifth examples, by setting the amount of shift that is smaller than the nozzle pitch P_{N} in the nozzle row direction between the heads of the different colors (and desirably to the amount of shift that is obtained by dividing the nozzle pitch P_{N} into n equal parts), it is possible to form images in which stripe non-uniformities caused by the deviations of the ejection directions (deposition position deviations) are not conspicuous.

In other words, the amount of relative shift in the recording positions in the x direction is set between the nozzles which eject ink droplets of a certain first color and the nozzles which eject ink droplets of a certain second color that is different to the first color, of the plurality of colors, in such a manner that dots formed by the ink droplets of the second color can be recorded on a line at positions in the nozzle row direction (x direction) (on the scanning line following the y direction) where dots to be formed by the ink droplets of the first color cannot be recorded. In this way, stripe non-uniformities caused by the deviations in the ejection directions (deposition position deviations) of the nozzles belonging to the nozzle row of one color can be made inconspicuous by the droplet depositions from the nozzles belonging to the nozzle row of another color.

### <Problem of Color Non-Uniformities Caused by Registration Shift>

Next, the problem of color non-uniformity due to a registration shift between the heads is described.

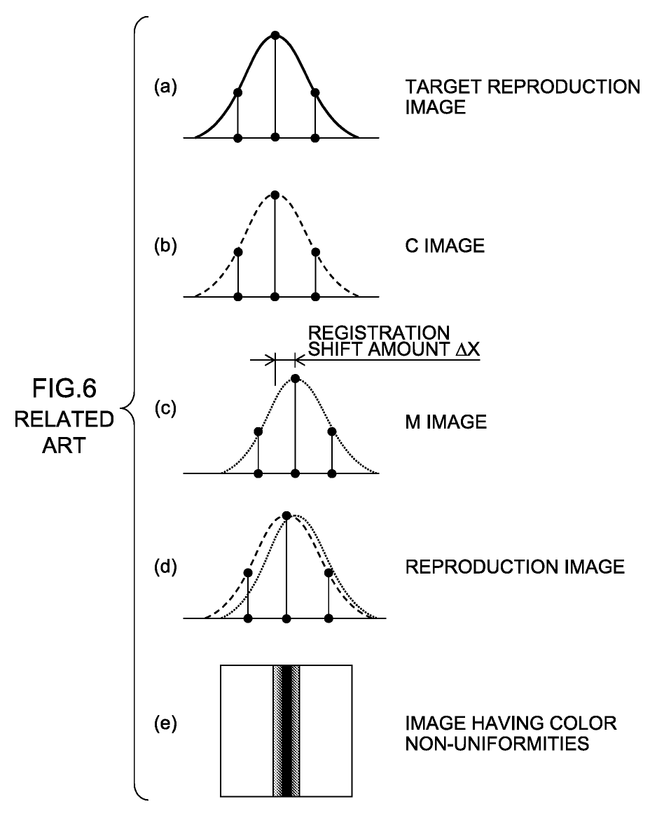

FIG. 6 is an illustrative diagram of causes of color non-uniformities caused by registration shift in the inkjet printing in the related art. FIG. 6 shows an example of a density profile of a target reproduction image in the secondary color composed of cyan and magenta, at a portion (a), in which the horizontal axis indicates the position and the vertical axis indicates the image density (a tone value representing the ink density). The respective positions indicated with the black circles on the horizontal axis indicate pixel positions (sampling points) of the image data.

FIG. 6 further shows cyan image data at a portion (b), and magenta image data at a portion (c). Here, the example is shown in which the arrangement of the magenta head is staggered by a registration shift amount of ΔX with respect to the cyan head.

When the registration shift amount ΔX has been set, if halftone processing is carried on the basis of the original pixel positions, without taking account of the registration shift amount ΔX, and image formation is carried out on the basis of the thereby obtained halftone signal, then as shown in FIG. 6 at a portion (d), deviations between the C image and the M image occur in the reproduction image, and hence an image having color non-uniformities is obtained. FIG. 6 shows, at a portion (e), a conceptual diagram of a reproduction image (a band-shaped image in the longitudinal direction) in which color non-uniformities have occurred due to the deviations between the cyan image positions and the magenta image positions. Here, the example has been described with respect to the secondary color composed of cyan and magenta, and similar problems occur with other combinations of ink colors.

### <Second Solution According to the Present Embodiment>

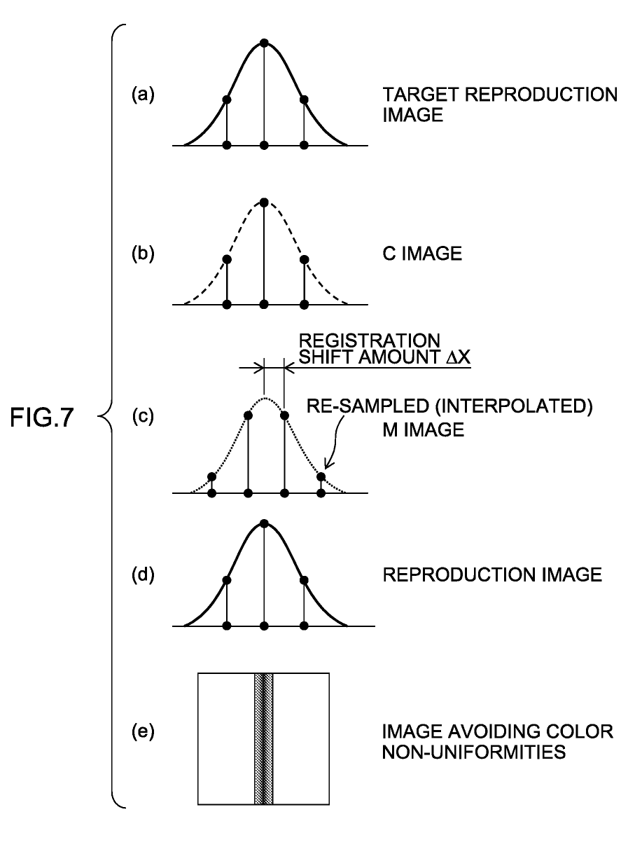

In the present embodiment, the problem illustrated in FIG. 6 is resolved as follows. FIG. 7 is an illustrative diagram of means of solution according to the present embodiment. Compared to the illustration in FIG. 6, FIG. 7 shows, similarly to FIG. 6 at the portion (a), an example of a density profile of a target reproduction image in the secondary color composed of cyan and magenta, at a portion (a), in which the horizontal axis indicates the position and the vertical axis indicates the image density (a tone value representing the ink density). The respective positions indicated with the black circles on the horizontal axis indicate pixel positions of the image data.

FIG. 7 further shows cyan image data at a portion (b), and magenta image data at a portion (c). Here, the example is shown in which the arrangement of the magenta head is staggered by a registration shift amount of ΔX with respect to the cyan head.

When the registration shift amount ΔX has been set, the sampling positions of the magenta image are corrected in accordance with the registration shift amount ΔX, and an interpolated image is generated so as to achieve a target reproduction image that takes account of the registration shift amount ΔX. For example, when the registration shift amount of the M head is set with respect to the C head so that each of magenta droplet deposition positions is exactly halfway between the cyan droplet ejection positions, then the interpolated image at the exact halfway positions (interpolation positions) between the pixels of the original image is generated and this image is sampled.

The digital image data is originally data indicating tone values (density values) corresponding to discrete pixel positions, and therefore if the sampling positions corresponding to the nozzle positions of the head are positions between the original pixels, due to the registration shift, then no signal values exist in the original image data. Therefore, the image (interpolated image) that is re-sampled at the interpolation positions which take account of the registration shift amount is generated from the original magenta image data so as to obtain the target reproduction image. In FIG. 7, the positions of the black circles shown on the horizontal axis at the portion (c) indicate the interpolation positions in the re-sampling process.

For cyan, the halftone processing is carried out directly on the original color separation image data, and for magenta, the halftone processing is carried out on the interpolated image generated by taking account of the registration shift amount. Image formation is carried out on the basis of the halftone signals (dot image data for the respective colors) thus obtained.

In the thus obtained reproduction image, as shown in FIG. 7 at a portion (d), there is no deviation between the C image and the M image, and color non-uniformities are avoided. FIG. 7 shows, at a portion (e), a conceptual diagram of a reproduction image (a band-shaped image in the longitudinal direction) that avoids color non-uniformities. Here, the example has been described with respect to the secondary color composed of cyan and magenta, and a similar procedure applies to other combinations of ink colors.

### <Concrete Example of Method of Generating Interpolated Image>

Next, a concrete example of a method of generating an interpolated image is described.

<<Target Reproduction Image>>

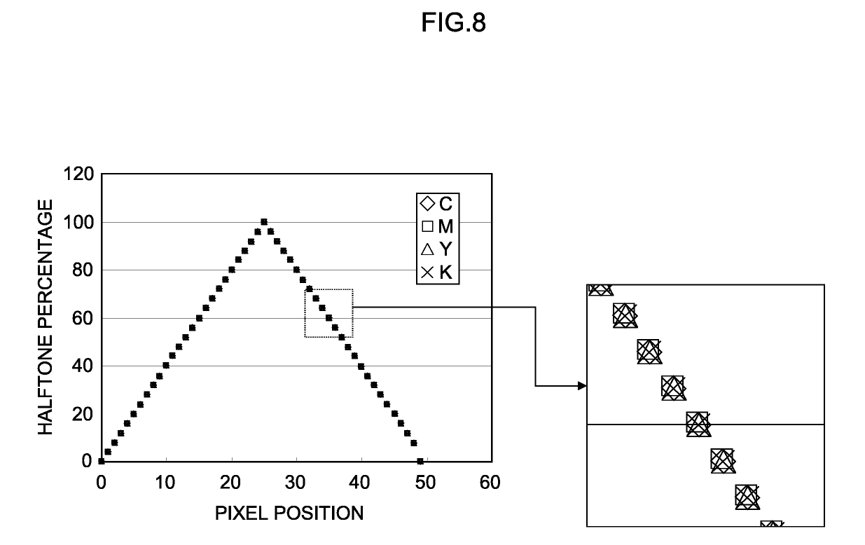

FIG. 8 shows an example of color separation image data for the respective colors of C, M, Y and K in the target reproduction image. In FIG. 8, the horizontal axis indicates the pixel position in the nozzle row direction, and the vertical axis indicates the halftone percentage.

FIG. 8 further shows a partially enlarged view of the graph. As shown in FIG. 8, in the color separation images, the colors overlap at the respective pixel positions.

<<Reproduction Image in Case of Registration Shift>>

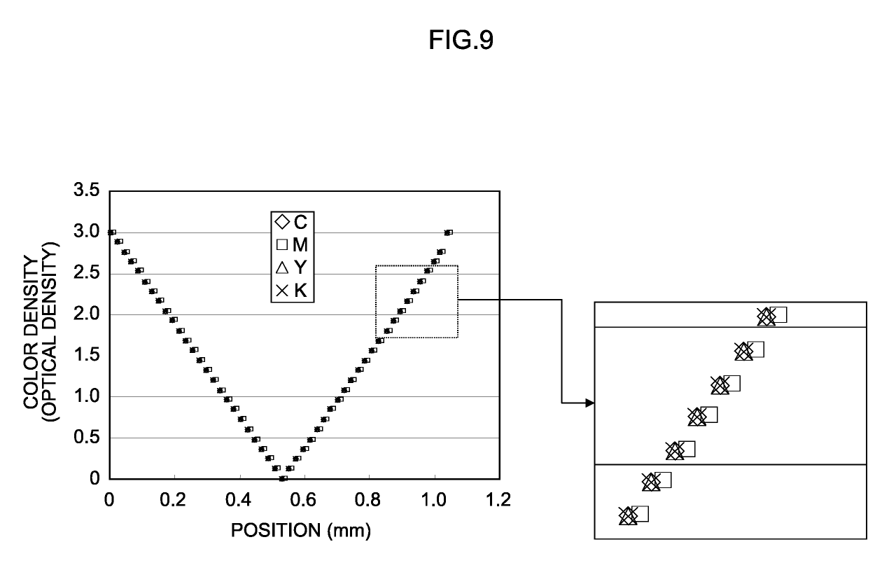

FIG. 9 shows image formation results when a registration shift has occurred in the M head in the inkjet recording apparatus which forms an image of the image data in FIG. 8. In FIG. 9, the horizontal axis indicates the position on the recording medium (the position in the nozzle row direction), and the vertical axis indicates an optical density (OD value) of each color. FIG. 9 further shows a partially enlarged view of the graph. When the registration shift has occurred in the M head, the color deviation occurs in the actual sample (printed object) due to the registration shift of the M color.

<<Generation of Interpolated Image Taking Account of Registration Shift>>

In order to prevent color deviation such as that illustrated in FIG. 9, correction taking account of the registration shift is carried out. The interpolated image is generated on the basis of the registration shift amount of magenta (M) (for example, a registration shift amount of 5 μm from the reference droplet deposition point), and the resolution information in the nozzle row direction of the head (for example, 1200 dpi (dots per inch)). Here, the interpolated image is created by linear interpolation. The interpolation method can employ various well known methods, such as a bicubic method, a bilinear method, and the like. There is a trade-off between calculation accuracy and calculation speed, and an optimal method can be selected from this perspective.

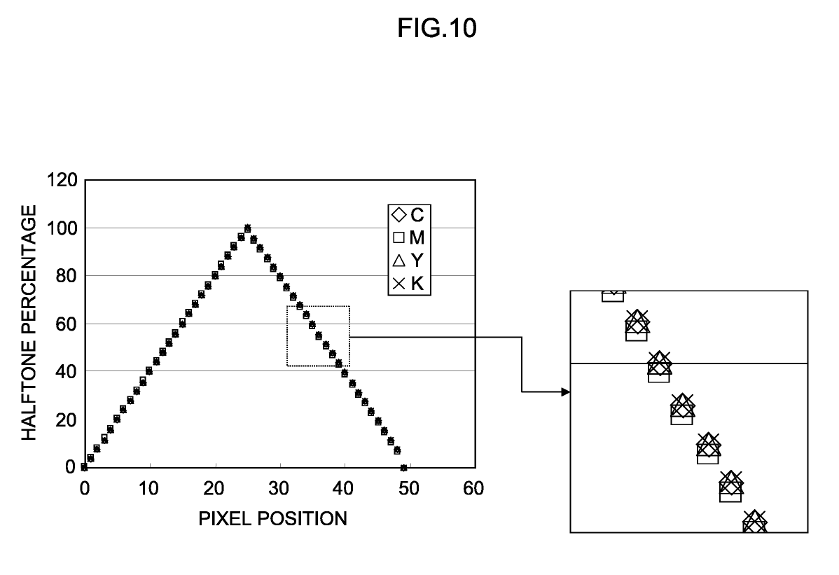

FIG. 10 shows an example of interpolated image data generated from the M color separation image. In FIG. 10, the color separation image data illustrated in FIG. 8 is shown for the colors (C, Y and K) apart from M. FIG. 10 further shows a partially enlarged view of the graph. As shown in FIG. 10, the image data for M is corrected by the interpolation calculation which takes account of the resolution and the registration shift amount.

<<Description of Interpolation Method by Bilinear Method>>

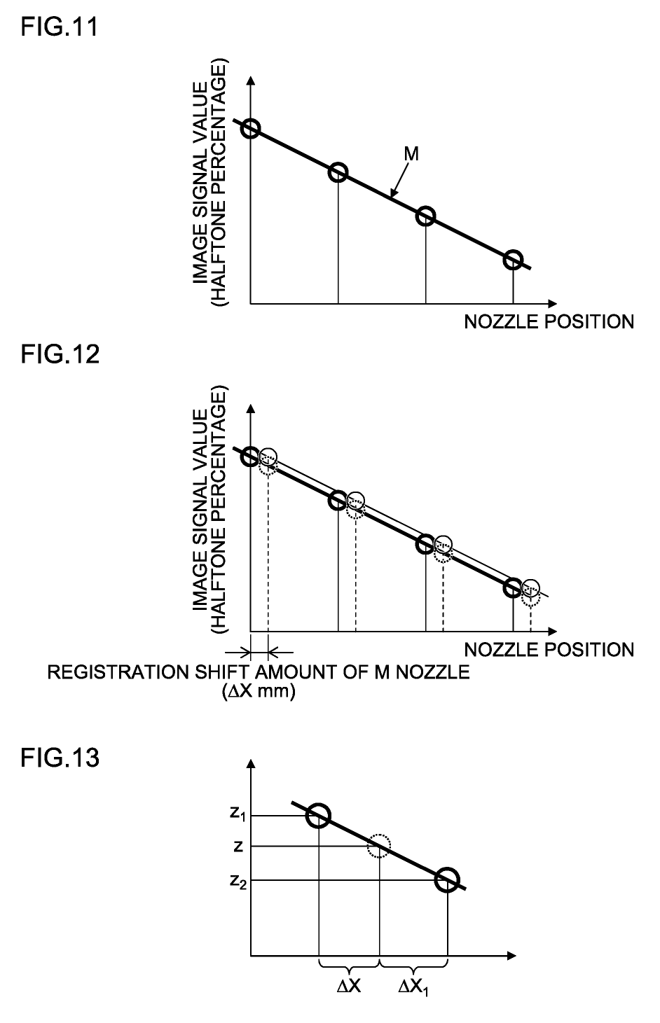

A case which uses the bilinear method is described here as one example of the interpolation method. FIG. 11 shows examples of image signal values in a color separation image for magenta (M). In FIG. 11, the horizontal axis indicates the nozzle position, and the vertical axis indicates the image signal value (halftone percentage). The nozzle positions herein referred to, correspond to the pixel positions in the nozzle row direction. The color separation image data, which is digital image data, is discrete data and the points surrounded by thick circles in FIG. 11 represent the actual signal values.

In a case where the nozzles of the M head have the registration shift of a registration shift amount of ΔX mm with respect to the reference position, if the color separation image for M is subjected directly to halftone processing without correction and then output for image formation, then as indicated with fine solid circles in FIG. 12, an M image is formed as the image in FIG. 11 having been shifted horizontally by the registration shift amount (ΔX) in the nozzle position direction, and hence there is deviation in the reproduced colors (the magenta hue becomes stronger).

Therefore, interpolation is carried out by linear interpolation, or the like, from the original image signal values (the values indicated with the thick solid circles), and an interpolated image as indicated with the dotted circles in FIG. 12 is generated. By thus correcting the color separation image data, accurate reproduced colors which are close to the target reproduction image are obtained.

FIG. 13 is an illustrative diagram of a specific interpolation calculation.

If the registration shift amount of ΔX (mm) and the resolution of D (dpi (dots per inch)) in the nozzle row direction are already known, then the linearly interpolated signal can be represented as:

z=(ΔX₁×z₁+ΔX×z₂)/(ΔX₁+ΔX),
where ΔX₁=(1″/D)×25.4−ΔX (here, 1″ represents one inch).

### <Flow of Image Processing in the Present Embodiment>

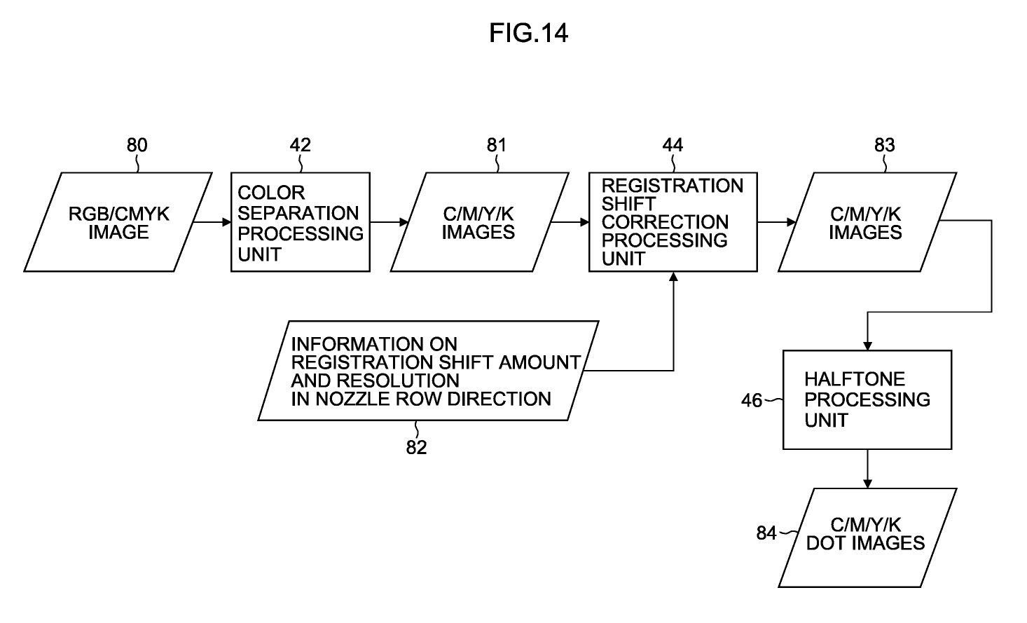

FIG. 14 is an illustrative diagram showing a sequence of image processing in the image processing device 32.

As shown in FIG. 14, the input RGB image or CMYK image 80 is divided into color separation image data 81 for the respective ink colors by the color separation processing unit 42. The color separation image data 81 for the respective ink colors generated by the color separation processing unit 42 is subjected to correction processing in the registration shift correction processing unit 44. In this correction processing, the information 82 on the registration shift amount and the resolution in the nozzle row direction is used, and an interpolated image is generated from the color separation image data of the color for which the registration shift has been set. Then, halftone processing is carried out by the halftone processing unit 46 on the image data 83 of the respective colors including the corrected interpolated image, and thereby halftone images (dot data) 84 of the respective colors are obtained.

The image processing device 32 achieving image processing of this kind can be realized by a computer. A program which causes the computer to function as the image processing device 32 including the color separation processing device (the color separation processing unit 42), the interpolated image generating device (the registration shift correction processing unit 44), the halftone processing device (the halftone processing unit 46) and the registration shift amount storage device (the registration shift amount information storage unit 48) can be installed beforehand in the computer. It is also possible to distribute a computer readable non-transitory medium, such as a magnetic disk, optical disk, magneto-optical disk, memory card, or the like, that stores the program. Furthermore, instead of a mode in which the program is stored on a tangible storage medium of this kind, it is also possible to distribute a signal representing the program through a download service, by using a communication network, such as the Internet.

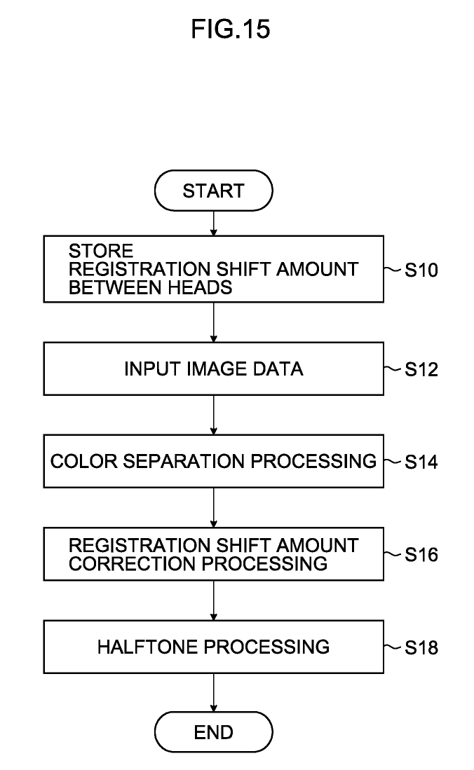

FIG. 15 is a flowchart showing a flow of image processing according to the present embodiment. Firstly, the registration shift amount between the heads is stored (step S10, corresponding to a “registration shift amount storage step”).

Next, image data that is to be printed is input (step S12). Color separation processing is carried out on the input image data, thereby obtaining color separation image data for the respective colors (step S14). The color separation image data thus obtained is then subjected to correction processing for generating an interpolated image that takes account of the registration shift amount (step S16, corresponding to an “interpolated image generating step”).

Then, halftone processing is carried out on the image data indicating the color-specific tone values including the obtained interpolated image, thereby generating halftone images for the respective colors (step S18, corresponding to a “halftone processing step”). The ink ejection operations of the heads of the respective colors are controlled on the basis of the halftone images thus generated.

According to the present embodiment, it is possible to obtain an image in which stripe non-uniformities due to the deviations of the ejection directions are not conspicuous, and it is also possible to obtain a good reproduction image that avoids color deviations and color non-uniformities caused by the registration shift. In the above-described first embodiment, the example incorporating the first and second solutions has been explained as the desirable embodiment; however, each of the first and second solutions can be used as independent technology.

### Second Embodiment

The following composition can be added in the above-described first embodiment.

In a case where a registration shift is previously set between specific heads, the registration shift amount can change according to use. In order to prevent color deviations caused by variation in the registration shift amount of this kind, it is possible to adopt a mode in which the registration shift amount between the heads is measured at a suitable timing, and an interpolated image is generated by taking account of the registration shift amount indicated by this measurement result.

It is possible to use a scanner which reads in a printed image, for example, as a device for determining the registration shift amount (a registration shift amount determination device). By using a scanner including imaging devices capable of color separation, such as a 3-CCD color line sensor having an array of CCD line sensors for three colors of RGB, respectively, it is possible to read in information for the respective colors which can be printed by the ink ejection mechanism 12.

Furthermore, in the case of the inkjet recording apparatus based on the signal pass method, a desirable composition is one in which the scanner serving as the image reading device, which reads an image after printing, is arranged in the medium conveyance path. This composition is desirable because, when printing a large number of sheets, it is possible to check the printed images, sheet by sheet, during paper conveyance.

For example, a line scanner having a photo-electric conversion element row (reading pixel row) capable of reading an image on a medium in the paper width direction, which is perpendicular to the medium conveyance direction, in one operation (in one paper conveyance action) is arranged in the medium conveyance path. According to this mode, an image on a medium is read in by the scanner while conveying the medium 24 formed with the image by the ink ejection mechanism 12 in one direction, and the image is then converted into an image signal.

A test chart, which enables confirmation of the droplet deposition positions of the respective nozzles, is output and by reading in the output results of this test chart by the scanner, electronic image data (read image data) of the read image is generated. By analyzing this read image data, it is possible to determine the registration shift amount.

After the registration shift amount obtained from the determination result has been stored in the registration shift amount information storage unit 48, an interpolated image is generated using this information and the information on the resolution, as described in relation to the first embodiment.

### Modification embodiment 1

In the first and second embodiments, from the viewpoint of increasing the robustness with respect to deviations in the nozzle ejection directions, it is presumed that the registration shift amount that is smaller than the pixel pitch is beforehand set between the heads of different colors; however, instead of a mode of this kind, it is also possible to start using the heads by initially adjusting the head positions in a state of no registration shift, and to then measure or determine the registration shift amount between the heads that occurs with use and to generate an interpolated image that takes this registration shift amount into account. In this case, even when the registration shift has occurred due to continuous use, it is possible to obtain a good reproduction image in which color non-uniformities are not conspicuous.

### Modification embodiment 2

Furthermore, in the embodiments described above, the inkjet recording apparatus using the page-wide full-line type heads having the nozzle rows of the length corresponding to the full width of the recording medium (a single-pass image forming apparatus, which completes an image by a single sub-scanning action) has been described; however, the application of the present invention is not limited to this, and the present invention can also be applied to an inkjet recording apparatus based on a multi-pass method, which performs image recording by means of a plurality of scanning actions with respect to a recording medium by moving short recording heads, such as serial heads (shuttle scanning heads), or the like.

In this case, if the direction of reciprocal movement of the heads is taken to be the “main scanning direction”, and the conveyance direction of the recording medium is taken to be the “sub-scanning direction”, then the nozzle rows in the heads have nozzles arranged in the sub-scanning direction. In the case of the inkjet recording apparatus based on the multi-pass method, the main scanning direction (head movement direction) corresponds to the “first direction”, and the sub-scanning direction corresponds to the “nozzle row direction” or “second direction”. Furthermore, a carriage and a drive mechanism for the carriage, which cause reciprocal movement of the heads correspond to the “relative movement device”.

### <Device for Causing Relative Movement of Head and Recording Medium>

In the embodiments described above, the embodiments are given in which the recording medium is conveyed with respect to the stationary heads, but in implementing the present invention, it is also possible to move heads with respect to a stationary recording medium (image formation receiving medium), or move both of the heads and the recording medium.

The full line type recording heads based on the single pass method are normally arranged in the direction perpendicular to the feed direction (conveyance direction) of the recording medium; however, a mode is also possible in which the heads are arranged in an oblique direction forming a certain prescribed angle with respect to the direction perpendicular to the conveyance direction. In this case also, it is possible to specify the effective nozzle row direction, nozzle pitch, pixel pitch, and the like, by defining two mutually intersecting axes (a first direction and a second direction).

### <Recording Medium>

The “recording medium” is a general term for a medium on which dots are recorded by droplets ejected from the inkjet heads, and this includes various terms, such as print medium, recorded medium, image formation medium, image receiving medium, deposition receiving medium, print sheet, and the like. In implementing the present invention, there are no particular restrictions on the material or shape, or other features, of the recording medium, and it is possible to employ various different media, irrespective of their material or shape, such as continuous paper, cut paper, seal paper, OHP sheets or other resin sheets, film, cloth, nonwoven cloth, a printed substrate on which a wiring pattern, or the like, is formed, or a rubber sheet.

### <Ejection Method>

The devices for generating ejection pressure (ejection energy) for ejecting the droplets from the nozzles in the inkjet heads can employ pressure generating elements (ejection energy generating elements) of various types, such as piezoelectric actuators (piezoelectric elements), electrostatic actuators, heaters (heating elements) in a thermal method (a method which ejects ink by using the pressure created by film boiling upon heating by heaters) or actuators of various kinds based on other methods. A corresponding energy generating element is arranged in the flow channel structure in accordance with the ejection method of the head.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet recording apparatus, comprising:
a plurality of inkjet heads which are arranged correspondingly to inks of a plurality of colors, each of the inkjet heads having nozzles configured to eject droplets of the ink of the corresponding color to deposit the ejected droplets of the ink onto a recording medium;
a relative movement device which is configured to cause relative movement of the recording medium with respect to the inkjet heads in a first direction;
a registration shift amount setting device which is configured to relatively set, between the inkjet heads corresponding to the colors different to each other, a registration shift amount of recording positions in a nozzle row direction of the inkjet heads along a second direction perpendicular to the first direction;
an interpolated image generating device which is configured to generate image data of an interpolated image from, among original image data representing tone values of the respective colors, the original image data of one of the colors corresponding to the inkjet head for which the registration shift amount has been set by the registration shift amount setting device, the image data of the interpolated image being generated in accordance with the registration shift amount;
a halftone processing device which is configured to generate color-specific halftone images by performing halftone processing on the image data of the interpolated image of the one of the colors and the original image data of the others of the colors; and
an ejection control device which is configured to control, in accordance with the color-specific halftone images generated by the halftone processing device, ejection operations of the inkjet heads of the corresponding colors.

2. The inkjet recording apparatus as defined in claim 1, wherein the plurality of colors include four colors of cyan, magenta, yellow and black.

3. The inkjet recording apparatus as defined in claim 1, wherein the registration shift amount set by the registration shift amount setting device is smaller than a pixel pitch in the second direction which is specified by a recording resolution in the second direction of the inkjet heads.

4. The inkjet recording apparatus as defined in claim 3, wherein the registration shift amount set by the registration shift amount setting device is obtained by dividing the pixel pitch in the second direction into n equal parts, where n is an integer larger than one.

5. The inkjet recording apparatus as defined in claim 4, wherein:
the inkjet heads include a black head configured to eject black ink, and a magenta head configured to eject magenta ink; and
the registration shift amount setting device sets the registration shift amount such that the black head and the magenta head are staggered relatively to each other by ½ of the pixel pitch in the second direction.

6. The inkjet recording apparatus as defined in claim 4, wherein:
the inkjet heads include a black head configured to eject black ink, and a cyan head configured to eject cyan ink; and
the registration shift amount setting device sets the registration shift amount such that the black head and the cyan head are staggered relatively to each other by ½ of the pixel pitch in the second direction.

7. The inkjet recording apparatus as defined in claim 4, wherein:
the inkjet heads include a magenta head configured to eject magenta ink, and a cyan head configured to eject cyan ink; and
the registration shift amount setting device sets the registration shift amount such that the magenta head and the cyan head are staggered relatively to each other by ½ of the pixel pitch in the second direction.

8. The inkjet recording apparatus as defined in claim 4, wherein:
the inkjet heads include a black head configured to eject black ink, a magenta head configured to eject magenta ink, and a cyan head configured to eject cyan ink; and
the registration shift amount setting device sets the registration shift amount such that the black head, the magenta head and the cyan head are staggered relatively to each other by ⅓ of the pixel pitch in the second direction.

9. The inkjet recording apparatus as defined in claim 4, wherein:
the inkjet heads include a black head configured to eject black ink, a magenta head configured to eject magenta ink, a cyan head configured to eject cyan ink, and a yellow head configured to eject yellow ink; and
the registration shift amount setting device sets the registration shift amount such that the black head, the magenta head, the cyan head and the yellow head are staggered relatively to each other by ¼ of the pixel pitch in the second direction.

10. The inkjet recording apparatus as defined in claim 1, wherein the interpolated image generating device is configured to perform interpolation processing from the original image data in accordance with the registration shift amount and information on a recording resolution in the second direction of the inkjet heads, and is configured to generate the image data of the interpolated image representing tone values which are re-sampled at interpolation positions taking account of the registration shift amount.

11. An image processing apparatus for an inkjet recording apparatus which includes: a plurality of inkjet heads which are arranged correspondingly to inks of a plurality of colors, each of the inkjet heads having nozzles configured to eject droplets of the ink of the corresponding color to deposit the ejected droplets of the ink onto a recording medium; and a relative movement device which is configured to cause relative movement of the recording medium with respect to the inkjet heads in a relative movement direction, the image processing apparatus comprising:
a registration shift amount storage device which is configured to store a registration shift amount of recording positions in a nozzle row direction of the inkjet heads perpendicular to the relative movement direction, the registration shift amount being relatively set between the inkjet heads corresponding to the colors different to each other;
an interpolated image generating device which is configured to generate image data of an interpolated image from, among original image data representing tone values of the respective colors, the original image data of one of the colors corresponding to the inkjet head for which the registration shift amount has been set, the image data of the interpolated image being generated in accordance with the registration shift amount; and
a halftone processing device which is configured to generate color-specific halftone images by performing halftone processing on the image data of the interpolated image of the one of the colors and the original image data of the others of the colors.

12. A computer readable non-transitory medium storing instructions causing a computer to function as the image processing apparatus as defined in claim 11.

13. An image processing method for an inkjet recording apparatus which includes: a plurality of inkjet heads which are arranged correspondingly to inks of a plurality of colors, each of the inkjet heads having nozzles configured to eject droplets of the ink of the corresponding color to deposit the ejected droplets of the ink onto a recording medium; and a relative movement device which is configured to cause relative movement of the recording medium with respect to the inkjet heads in a relative movement direction, the method comprising:
a registration shift amount storage step of storing a registration shift amount of recording positions in a nozzle row direction of the inkjet heads perpendicular to the relative movement direction, the registration shift amount being relatively set between the inkjet heads corresponding to the colors different to each other;
an interpolated image generating step of generating image data of an interpolated image from, among original image data representing tone values of the respective colors, the original image data of one of the colors corresponding to the inkjet head for which the registration shift amount has been set, the image data of the interpolated image being generated in accordance with the registration shift amount; and
a halftone processing step of generating color-specific halftone images by performing halftone processing on the image data of the interpolated image of the one of the colors and the original image data of the others of the colors.
